(19) United States
(12) Patent Application Publication
(10) Pub. No.: US 2005/0244619 A1
(43) Pub. Date: Nov. 3, 2005

(54) Plastically deformable nonwoven web

(76) Inventors: Michael Kauschke, Prien/Bachham (DE); Mordechai Turi, Princeton Junction, NJ (US)

Correspondence Address: AMSTER, ROTHSTEIN & EBENSTEIN LLP, 90 PARK AVENUE, NEW YORK, NY, 10016, US

(21) Appl. No.: 11/107,555

(22) Filed: Apr. 15, 2005

Related U.S. Application Data
(60) Provisional application No. 60/562,969, filed on Apr. 16, 2004.

(51) Int. Cl. B32B 7/08; B32B 3/10; B32B 27/12

(52) U.S. Cl. 428/195.1; 442/401; 442/361; 442/400; 442/351; 442/408; 428/903; 428/198; 428/365; 428/373; 428/374; 264/103; 264/145; 264/164; 264/165; 442/328; 442/329; 442/394; 442/398; 442/276; 442/268; 442/382; 442/384; 442/385; 264/154; 428/131

(57) ABSTRACT

A nonwoven web formed of substantially continuous spunmelt fibers is formed from a homopolymer of polypropylene having a skewed molecular weight distribution and a polydispersity of less than 3.5. The web, when subjected to high speed incremental deformation, is plastically deformed and characterized by, e.g., a tensile strength at 400% elongation which is at least 10% of the peak tensile strength, a tensile strength at 250% elongation which is at least 40% of the peak tensile strength, and a ratio of the viscoelastic deformation energy after the peak tensile strength to the viscoelastic deformation energy before the peak tensile strength which is greater than one.

### CROSS-REFERENCE TO RELATED APPLICATION

This application claims the benefit of U.S. Provisional Application No. 60/562,969, filed Apr. 16, 2004.

### BACKGROUND OF THE INVENTION

The present invention relates to a nonwoven web formed of substantially continuous spunmelt fibers comprising a homopolymer of polypropylene, and more particularly to such a web which is plastically deformable when subject to high speed incremental deformation to contribute to its structural extensibility.

It is well-known to prepare a nonwoven web formed of substantially continuous spunmelt fibers where the web is plastically deformable when subjected to high speed incremental deformation to contribute to its structural extensibility in at least one direction. The fibers used in such a web are typically either bicomponent fibers, such as disclosed in Gillespie, et al. U.S. Pat. No. 6,632,504, or copolymer compositions, such as disclosed in Bugada, et al. U.S. Pat. No. 6,569,945. For example, the bicomponent fibers may include polypropylene and a more easily deformable polymer such as polyethylene, and the copolymer may be basically formed from propylene monomer with lesser amounts of a comonomer such as ethylene. This approach has not proven to be entirely satisfactory. The equipment and process cost involved in preparing a bicomponent fiber or a copolymer fiber usually substantially exceed the costs involved in preparation of a homopolymer such as a homopolymer of polypropylene. Additionally, there are limits on the possible ratios of particular components or monomers, thereby restricting the bicomponent or copolymer resins available as a practical matter. Thus nonwoven webs formed of a homopolymer only (such as polypropylene homopolymer) are not only less expensive, but generally preferred.

Interestingly, even aside from the higher costs of a bicomponent fiber, typically the conventional bicomponent fiber, whether of the sheath/core or side-by-side configuration, has not proven to be entirely satisfactory in use. For example, the components of polypropylene/polyethylene bicomponent fibers are essentially immiscible and therefore tend to separate because the polymeric components thereof differ in essential ways, such as the shrinkage characteristics as a function of temperature, in plastic deformation characteristics, and in the capacity to bond with other polymeric materials. Accordingly, conventional bicomponent fibers are typically characterized not only by the higher costs thereof, but also by a lack of suitability for various applications.

A plastically deformable web would find broad utility as a laminate or composite with other functional sheet materials such as nonwovens, textiles or films. The ability of the web to plastically deform, especially when subjected to high speed incremental deformation, would make the web useful in any laminate or composite (with the web as the top, bottom or intermediate sheet or layer thereof). However the web would be especially useful in the case of a laminate or composite which would be exposed to frequent hysteretis stress/strain deformation because the web would more easily follow the stress/strain movements of the other layer or layers without complete failure, breakage or disintegration of the laminate structure, even where the other sheets or layers were elastic (e.g., elastic nonwoven webs, textiles or films).

A plastically deformable web would be extremely useful in forming a hydroentangled or hydroengorged single layer nonwoven or a hydroentangled or hydroengorged laminate or composite of at least two nonwoven fiber layers—e.g., two outer spunbond nonwoven webs and an intermediate layer therebetween formed, for example, of wood pulp, cellulosic fibers, viscose fibers, or combinations thereof. During a hydroentanglement process an initial water jet may cause entanglement, for example, of one portion of a substantially continuous fiber in one layer with other fibers in the immediate vicinity (whether of the same or another layer), but a subsequent water jet acting on the same continuous fiber may, in the process of causing entanglement of another portion of the continuous fiber, cause the previous entanglement to disentangle. Actually this undesirable disentanglement phenomenon occurs with great frequency where the continuous fiber is more or less of a fixed length between adjacent bonding points and would be reduced if the continuous fiber were capable of plastic deformation and therefore sufficiently structurally extensible or elongatable between adjacent bonding points to enable each of the two portions to more or less independently hydroentangle with the other fibers.

Accordingly, it is an object of the present invention to provide in one preferred embodiment a nonwoven web formed of substantially continuous spunmelt fibers comprising a homopolymer of polypropylene, the web being plastically deformable when subjected to high speed incremental deformation to contribute to its structural extensibility in at least one direction.

Another object is to provide such a web wherein in one preferred embodiment the continuous fibers are hydroentangled or hydroengorged.

Yet another object to provide in one preferred embodiment a hydroentangled laminate comprising, for example, two outer spunbond layers and an intermediate layer therebetween formed, for example, of wood pulp, cellulosic fibers, viscose fibers or combinations thereof.

A further object is to provide in one preferred embodiment a composite (e.g., a laminate) of such a web and a nonwoven or film in which the nonwoven or film is elastic.

A further object is to provide in one preferred embodiment a composite (e.g., a laminate) of such a web and a nonwoven or film in which the nonwoven or film is breathable.

It is also an object of the present invention to provide in one preferred embodiment a bicomponent fiber comprising a component of polypropylene and a component of polyethylene, both components being substantially similar in shrinkage characteristics as a function of temperature, in plastic deformation characteristics, and in the capacity to bond with other polymeric materials.

It is a further object to provide, in one preferred embodiment, a method for making such a monocomponent fiber of polypropylene homopolymer, such a bicomponent fiber and such a web, composite or laminate.

### SUMMARY OF THE INVENTION

It has now been found that the above and related objects of the present invention are obtained in a nonwoven web formed of substantially continuous spunmelt fibers comprising a novel homopolymer of polypropylene according to the present invention. The web, when subjected to high speed incremental deformation, is plastically deformed and, in at least one direction, is characterized by at least one of (i) a tensile strength at 400% elongation which is at least 10% of the peak tensile strength, (ii) a tensile strength at 250% elongation which is at least 40% of the peak tensile strength, and (iii) a ratio of the viscoelastic deformation energy after the peak tensile strength to the viscoelastic deformation energy before the peak tensile strength which is greater than one.

Preferably, the web is characterized by at least two of characteristics (i), (ii), and (iii), and optimally by each of characteristics (i), (ii), and (iii). Preferably the tensile strength at 450% elongation is at least 10% of the peak tensile strength, the tensile strength at 250% elongation is at least 50% of the peak tensile strength, and the viscoelastic deformation energy ratio is at least two.

In one preferred embodiment, the novel homopolymer is a physical blend of at least two homopolymers of polypropylene, at least one of the at least two homopolymers having a polydispersity of less than 3.3, the at least two homopolymers having a substantially different weight average molecular weight. After blending, the at least two homopolymers in combination having a skewed molecular weight distribution and a polydispersity of less than 3.5. Alternatively, the novel homopolymer is a reaction product having a polydispersity of less than 3.5 and a skewed molecular weight distribution.

Preferably, the skewed molecular weight distribution is characterized (i) below the peak weight average molecular weight, by a gradual slope and a long tail towards the low molecular weights, and (ii) above the peak weight average molecular weight, by a steep slope and a short tail towards the high molecular weights. The skewing of the molecular weight distribution of the novel homopolymer contributes to the structural extensibility of the web substantially beyond its elongation at peak tensile.

In one preferred embodiment, the high speed incremental deformation is at least 400 mm/minute applied to an original undeformed dimension not greater than 0.5 inch. The high speed incremental deformation occurs at a web temperature of ambient or higher (e.g., 50-80° C.) A web made of the novel homopolymer (in combination with the processing parameters defined hereinbelow) typically exhibits a low elastic and high plastic resistance during high speed incremental deformation.

The continuous fibers either are spunbond and have a diameter of 10-50 microns or are meltblown and have a diameter of 0.5-10 microns. The continuous fibers of the web are preferably asymmetrically bonded (e.g., in a PILLOW BOND pattern) and hydroentangled.

The present invention also encompasses a novel nonwoven web formed of substantially continuous spunmelt fibers comprising a homopolymer of polypropylene. The homopolymer is either the aforementioned physical blend of at least two homopolymers of polypropylene or the aforementioned reaction product. The novel web, when subjected to high speed incremental deformation, is plastically deformed and has a structural extensibility in at least one direction.

The present invention further encompasses a method of making a novel nonwoven web formed of substantially continuous spunmelt fibers, comprising the step of forming a spunbond nonwoven web comprising fibers of the novel homopolymer of polypropylene using (i) quench air at 8-20° C. (preferably 12-14° C.), (ii) a fiber speed of 500-2,500 meters/minute (preferably 1,000-2,000 m/min.), and (iii) a bonding temperature of 75-150° C. (preferably 110-125° C.). The resultant web, when subjected to high speed incremental deformation, is plastically deformed and is characterized, in at least one direction, by at least one of the aforementioned characteristics (i), (ii) and (iii).

The present invention also extends to a bicomponent fiber comprising a component of polyethylene or polypropylene polymer and a component of the novel homopolymer of polypropylene. The two components are preferable in a sheath/core configuration with the components selected to be substantially similar in shrinkage characteristics as a function of temperature, in plastic deformation characteristics, and in the capacity to bond with other polymeric materials. Alternatively, the two component are preferably in a side-by-side configuration with the components selected to be substantially dissimilar in shrinkage characteristics as a function of temperature in order to provide a bimetal effect.

The present invention also extends to a splittable bicomponent fiber comprising a component of polyethylene or polypropylene polymer and a component of the novel homopolymer of polypropylene. The two components are preferably in a “pie” configuration with the components selected to be substantially non-adherent to one another in order to facilitate splitting thereof during secondary treatment.

The present invention further extends to a multilayer laminate or composite comprising a novel web of the novel homopolymer of polypropylene and at least one other web selected from the group consisting of nonwovens, woven textiles, films and combinations thereof. Preferably, the at least one other web is a nonwoven or a breathable film, or an elastic nonwoven or an elastic film. The at least one other web is preferably a film of polyethylene homopolymer, a polyethylene copolymer, or a blend thereof.

Also encompassed by the present invention is a hydroentangled or hydroengorged single layer web of the present invention or a hydroentangled or hydroengorged multilayer laminate, especially a laminate comprising two outer spunbond layers made of the novel web and an intermediate layer therebetween formed at least of wood pulp, cellulosic fibers, viscose fibers or combinations thereof.

Further encompassed by the present invention is a method of forming an apertured web suitable for use as an apertured topsheet, comprising the steps of providing a novel web of the homopolymer of polypropylene, calendering the web to create frangible secondary bonds therein, and plastically deforming the calendered web by high speed incremental deformation to create apertures therein. Alternatively, the present invention encompasses a method of forming an apertured nonwoven web by providing a novel web of the homopolymer of polypropylene and then creating apertures in the nonwoven web either by sucking hot air through a screen supporting the nonwoven web or by hot needling the nonwoven web—e.g., by hot air or by hot needles.

### BRIEF DESCRIPTION OF THE DRAWING

The above and related objects, features and advantages of the present invention will be more fully understood by reference to the following detailed description of the presently preferred, albeit illustrative, embodiments of the present invention when taken in conjunction with the accompanying drawing wherein:

FIG. 1 is a comparative schematic of a skewed molecular weight distribution curve for a typical homopolymer of polypropylene according to the present invention relative to a standard or normal curve for a conventional homopolymer of polypropylene;

FIG. 2A is a comparative schematic of a graph of tensile stress as a function of web elongation (i.e., a stress/strain curve) for a homopolymer of polypropylene according to the present invention relative to that of a conventional homopolymer of polypropylene, when tested with differing crosshead speeds;

FIG. 2B is a schematic illustration of a graph of tensile stress as a function of web elongation for a web of a single homopolymer of polypropylene according to the present invention, when tested with differing grip distances, with viscoelastic deformation energy parameters indicated;

FIG. 3 is a comparative schematic illustration of a graph similar to the graph of FIG. 2B but comparing the curves for actual test results with the hypothetical curve specified in the claims;

FIGS. 4A-4D are schematic illustrations of composites of a web according to the present invention and a nonwoven, woven textile, film or a combination thereof wherein:

FIG. 4A shows an adhesively bonded 2-layer composite,

FIG. 4B shows an adhesively bonded 3-layer composite,

FIG. 4C shows a non-adhesively bonded 2-layer composite, and

FIG. 4D shows a non-adhesively bonded 3-layer composite;

FIG. 5 is a schematic illustration of different types of bicomponent fibers according to the present invention;

FIG. 6A is a schematic illustration of a web according to the present invention both before (top) and after (bottom) hydroentanglement or hydroengorgement, and as a control a conventional web after hydroentanglement or hydroengorgement (middle), each to a comparable greatly enlarged scale;

FIG. 6B is similar to FIG. 6A, but to a greatly enlarged scale and without the control;

FIG. 7 is a schematic illustration to a greatly enlarged scale of a spunbond-pulp-spunbond composite after hydroentanglement or hydroengorgement;

FIG. 8 is a comparative stress/strain graph for various samples according to Example 2; and

FIG. 9 is a comparative stress/strain graph for various samples according to Example 3.

### DETAILED DESCRIPTION OF THE PREFERRED EMBODIMENTS

Polyolefins like polypropylene (PP) consist, in terms of their molecular structural morphology, of amorphous and crystalline portions where the weight ratio between the two portions (i.e., the degree of crystallinity) is mainly determined by molecular weight distribution, chain lengths and crystal size, by process conditions during converting, and by the solidified (“frozen”) molecular orientation in the final body form (like monoaxial drawn fibers with a high degree of molecular orientation parallel to the longitudinal extension of the fiber).

Polyolefins like PP are also characterized as having a structural-viscosity. In the solidified state and under a given temperature a formed PP body always exhibits when subjected to a mechanical deformation a plastic flow and an elastic response (in general called a “memory effect”). This combination of the two reactions (i.e., plastic flow and elastic response) depends strongly on the temperature of the polymer and the speed of deformation. In other words, the higher the temperature, the more plastic the flow; the lower the temperature, the more elastic the response. The higher the speed of a deformation (i.e., the less time given to deform) the more reversible or “elastic” is the response of the PP body; and the slower the speed of a deformation, the more non-reversible or plastic (i.e., the less reversible or elastic) is the response.

A main object of the novel PP of the invention is to reduce/decrease the reversible elastic behavior of a fibrous web, such as a nonwoven, even under high speed/short time deformation, and to increase the non-reversible plastic flow behavior.

The novel PP has a broad molecular weight distribution (i.e., polydispersity) wherein the long chain molecules still maintain sufficient integrity in terms of their chain length and the short chain molecules still maintain the plastic flow behavior so that the novel PP demonstrates an improved non-reversible or plastic deformation response especially when subjected to a high speed incremental (short distance) deformation—which is called “structural extensibility.” The novel nonwoven web is the structure formed by fibers of the novel PP with the modified morphological structure.

One main target during spinning and drawing of the fibers is to enhance the viscous aspect and decrease the elastic aspect of the re-crystallized fibers. Thus, targeted physical properties represented and measured by, for example, tensile strength and elongation are strongly dependent on—and can be modified and influenced—both by the polymer composition and the main process parameters. The processing behavior and resulting physical properties of the polymers are influenced by the width and shape of the polydispersity or molecular weight distribution curve of the polymer composition, as discussed below.

Another main target in the production of a nonwoven web from such viscoelastic fibers is maintenance of the fiber characteristics and the “transfer” of them, as much as possible, to the characteristics or properties of the web made from such fibers. Therefore the thermal bonding conditions (e.g., the bonding temperature and the bonding pattern), web formation, randomized fiber laydown, and fiber orientation are of importance to achieving of the targeted performance of the web. A preferred bonding area percentage is 5-25%, more preferably 10-20%.

In one aspect, the present invention is a novel nonwoven web formed of substantially continuous spunmelt fibers comprising a homopolymer of polypropylene. The spunmelt fibers are used to form a nonwoven fabric or web which is either spunbond (typically having a fiber diameter of 10-50 microns) or meltblown (typically having a fiber diameter of 0.5-10 microns). Spunmelt fibers (both spunbond and meltblown) are well known in the nonwoven polymer art and hence need not be described herein in further detail.

The novel homopolymer of polypropylene useful in the present invention is either a reaction product (that is, a product formed in a polymerization vessel by a polymerization reaction process) or a physical blend of at least two homopolymers of polypropylene (each homopolymer being made in a different polymerization reaction vessel process). As the physical blend is formed of at least two homopolymers of the same polymer (namely, polypropylene), the homopolymer components thereof are miscible and, as such, form a single continuous phase. Prior to physical blending, the at least two homopolymers of polypropylene have substantially different weight average molecular weights.

Where the novel homopolymer is a two component blend, one homopolymer component may have a weight average molecular weight characterized, for example, by a melt flow rate (MFR) of about 12-14 grams per 10 minutes, and the other homopolymer component may have a weight average molecular weight characterized, for example, by a melt flow rate of about 90-100 grams per 10 minutes. Where the novel hompolymer is a three component blend, the three components may have weight average molecular weights characterized, for example, by melt flow rates of about 12-14, 36-40 and 90-100 grams per 10 minutes, respectively. The melt flow rates given herein are determined by ASTM D-1238 Condition L (230° C./2.16 kg). These MFR values are obtained directly in polymerization (“as polymerized”). In essence, polymer resins having a high MFR consist predominantly of medium and small size molecules, while polymer resins having a low MFR consist predominantly of medium and large size molecules.

Polydispersity is a characteristic of a polymer reflecting the sharpness of the molecular weight distribution (MWD) curve of the polymer and is defined by the following formula:

$$P D = \frac{{M}_{w}}{{M}_{n}}$$

where
   PD=polydispersity,
   M_{w}=weight average molecular weight of the polymer, and
   Mₙ=number average molecular weight of the polymer.

The lower the polydispersity, the narrower and sharper the molecular weight distribution curve; the higher the polydispersity, the broader and more blunt the molecular weight distribution curve.

Where the homopolymer useful in the present invention is a physical blend of at least two constituent homopolymers of polypropylene, at least one of the two homopolymers preferably has a polydispersity of less than 3.3. In other words, at least one possesses a relatively narrow molecular weight distribution curve. After blending, the at least two homopolymers in combination (that is, the blend) has a polydispersity of less than 3.5. The increase in polydispersity (from less than 3.3 for one component to 3.5 for the blend) results from the blending together of at least two homopolymers where each of the at least two homopolymers is characterized by a substantially different weight average molecular weight. Where the homopolymer is a reaction product, it has a polydispersity of less than 3.5 (that is, a polydispersity limit similar to that required for the blend). The appropriate polydispersity of the homopolymer is a significant factor in ensuring that it possesses a desirable melt flow rate (MFR) for producing a spunmelt fiber (and in particular that there is a sufficient number of high molecular weight polymer molecules to provide a desirably low melt flow rate). For “spinnable” homopolymers of polypropylene for use in spunmelt processes, an MFR of 15-40 is preferred for spunbonds, and an MFR of 400-3,000 grams/10 minutes is preferred for meltblowns.

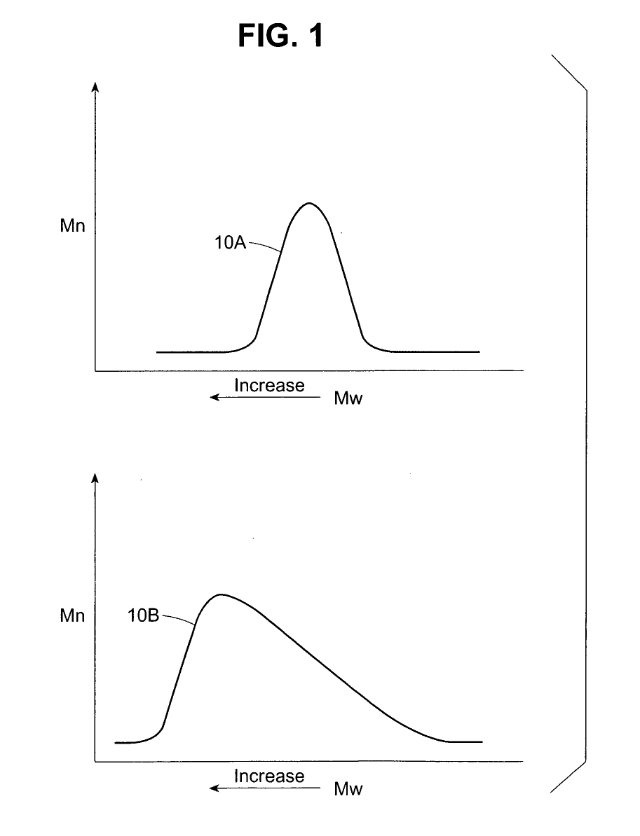

Regardless of whether the homopolymer is a reaction product or a physical blend, it is characterized by a skewed molecular weight distribution. Referring now to FIG. 1 in particular, therein illustrated are two molecular weight distribution curves showing the number of molecules (i.e., polymer chains) at each molecular weight (that is, at each polymer chain length). The molecular weight distribution curve 10A at the top of FIG. 1 illustrates the non-skewed normal or Gaussian molecular weight distribution of a conventional homopolymer of polypropylene, while the curve 10B at the bottom of FIG. 1 illustrates the skewed distribution of a novel homopolymer useful in the present invention. It will appreciated that the normal or Gaussian molecular weight distribution curve 10A shows, on either side of the peak weight average molecular weight, a tail of equal slope and equal length extending in opposite directions towards the absicca or X-axis. By way of contrast, the skewed molecular weight distribution curve 10B shows, below the peak weight average molecular weight, a long tail of gradual slope extending towards the low molecular weights and, above the peak weight average molecular weight, a short tail of steep slope extending towards the high molecular weights. Qualitatively speaking, the skewed molecular weight distribution curve 10B of the novel homopolymer reflects a larger number of high molecular weight molecules and a relatively small but yet substantial number of low molecular weight molecules. It is theorized that the skewing of the molecular weight distribution of the novel homopolymer contributes to the structural extensibility of the nonwoven web substantially beyond its elongation at peak tensile, as will be described and explained in further detail herein below.

The term “novel homopolymer” as used herein and in the claims refers to a homopolymer of polypropylene exhibiting the skewed molecular weight distribution described immediately hereinabove and in contradistinction to a “conventional” homopolymer of polypropylene which exhibits the normal or Gaussian molecular weight distribution also described immediately hereinabove

Where the novel homopolymer is a physical blend, one can obtain the desired skewed molecular weight distribution through an appropriate selection of the at least two conventional homopolymers of polypropylene and the blending of appropriate quantities thereof. The physical blend may be a simple physical blend of pellets of one conventional homopolymer and pellets of the other conventional homopolymer or it may be a compounded physical blend. In a compounded physical blend a simple physical blend is mixed and melted, the product then being re-pelletized so that each newly formed pellet contains both conventional homopolymers. However, the blending thereof represents an additional and arduous process step which may be relatively inconsequential in the manufacture of laboratory or test-scale quantities of the novel homopolymer, but becomes not only expensive but time-consuming and arduous in the context of a commercial-scale production of the novel homopolymer since the capacity and speed of commercially available blenders is quite limited and not well suited for large scale commercial production. On the other hand, where the novel homopolymer is a reaction product, the desired skewed molecular weight distribution may be more difficult to obtain but the process is better suited for large scale commercial production precisely because it avoids the need to physically blend different reaction products.

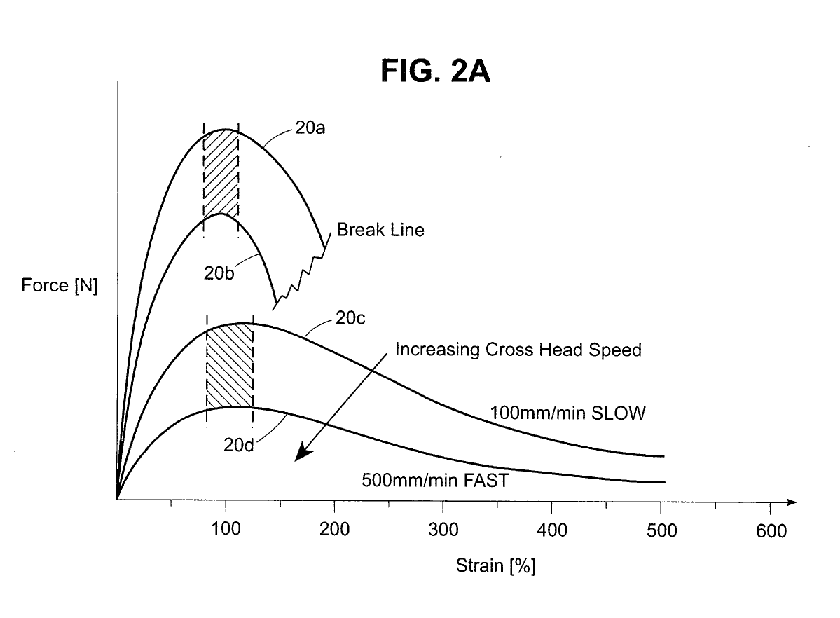

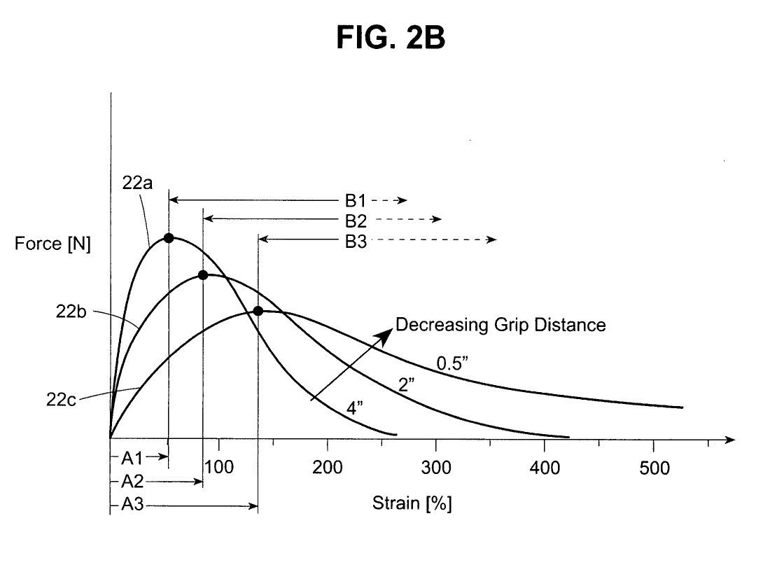

Referring now to FIGS. 2A and 2B in particular, the novel nonwoven web of the present invention, made from the novel homopolymer, is preferably characterized in at least one direction by at least one of three factors as follows:
(i) a tensile strength at 400% elongation (preferably at least 450% elongation) which is at least 10% of the peak tensile strength,
(ii) a tensile strength at 250% elongation which is at least 40% (preferably at least 50%) of the peak tensile strength, and
(iii) a ratio of the viscoelastic deformation energy after the peak tensile strength to the viscoelastic deformation energy before the peak tensile strength which is greater than one (preferably greater than 2).

The novel web exhibits at least one of the three factors or characteristics (i), (ii) and (iii), preferably at least two thereof, and optimally all three thereof. Webs according to the present invention may have a basis weight of 10-80 gsm with 15 and 35 gsm being representative.

Each of the three factors or characteristics can be measured using an Instron Series IX tensile tester. The tester can be set to provide the tensile strength of the sample web being tested (i.e., the force or load being applied) at its peak tensile strength, its elongation at the peak tensile strength, and its tensile strength at various other elongations. The elongations or strains are given as a percentage—e.g., 200% elongation, 250% elongation, 400% elongation, 450% elongation, etc.—relative to the original unstretched length of the sample being tested.

A tensile tester typically provides for a variable crosshead speed (that is, the speed at which the two grips or jaws grasping the sample move apart during testing) of 50-500 millimeters per minute. As schematically illustrated in FIG. 2A, faster elongations (that is, higher crosshead speeds) tend to reduce the tensile strengths for comparable elongations. The arrow of FIG. 2A indicates increasing crosshead speed from 100 mm/min to 500 mm/min. For comparative purposes FIG. 2A shows the range of test results on a conventional spunbond nonwoven web between the two curves 20a, 20b at the top, and the range of test results on a spunbond nonwoven web according to the present invention between the two curves 20c, 20d at the bottom. The upper 20a, 20c curve of each set was determined using a slow crosshead speed (100 mm/min) while the lower 20b, 20d curve was determined using a fast crosshead speed (500 mm/min). The shaded area between the curves of each set represents the range of peak elongations for that set. Unless otherwise stated, the “high speed” crosshead speed used herein (as in “high speed incremental deformation”) is 500 mm/min.

A tensile tester typically provides for a variable grip distance (that is, the initial longitudinal separation between the grips or jaws gripping the sample adjacent its two longitudinal ends) of 0.3-8 inches. To avoid the effect of web irregularities and other defects unrelated to the plastic deformation of the fibers of the web sample being tested, ideally the grip distance should not exceed the distance between the bonding points of the web sample. Accordingly, as schematically illustrated in FIG. 2B, decreasing the grip distance tends to move the stress/strain curve for a given sample 22a, 22b, 22c towards higher elongations. The arrow of FIG. 2B indicates decreasing grip distances until the effect of defects in the web is minimized. As the spacing between bonding points may in fact be significantly smaller than 0.5 inch, the use of a 0.5 inch grip distance represents only a practical attempt to simulate the actual spacing between bonding points. Such an approximation to the “incremental” stretching ideal is required because of the practical physical limitations in the set-up of the samples for testing (e.g., how closely the grips or jaws can be placed on a sample). Unless otherwise stated, the “incremental” grip distance spacing used herein (as in “high speed incremental deformation”) is 0.5 inch.

The term “high speed incremental” elongation or deformation is used to reflect the characteristics of the apparatus and processes used for large scale commercial deformation. Such high speed incremental deformation apparatus is well-known in the nonwoven art and employs procedures such as “ring rolling” and “tenter stretching,” as disclosed in Gillespie, et al., U.S. Pat. No. 6,632,504; Anderson, et al., U.S. Pat. No. 6,605,172; Curro, et al., U.S. Pat. No. 6,506,329; Weil, et al., U.S. Pat. No. 5,242,436 and Chappell PCT Publication No. WO 95/03765, each of these documents being incorporated herein by reference. As used herein, preferably high speed incremental deformation refers to deformation tested at a crosshead speed of at least 400 (preferably 500) millimeters/minute, as applied to an original undeformed dimension or grip distance not greater than 0.5 inch.

While the Instron Series IX Tensile Tester performs the high speed incremental deformation only at ambient web temperatures, there exist other tensile testers which include means for maintaining the web at specific temperatures during deformation. To mimic commercial high speed incremental deformation, a web temperature above ambient and up to 80° C. (optimally 50-80° C.) is preferred to support plastic (i.e., viscoelastic) deformation.

Referring now to FIGS. 1 and 2A in particular, we have seen that the skewing of the molecular weight distribution curve according to the present invention (that is, the bottom curve 10B of FIG. 1 relative to the top curve of 10A FIG. 1) ensures that the novel homopolymer composition will be characterized, relative to a conventional homopolymer composition, both by a larger number of high molecular weight molecules and a relatively small but yet substantial number of low molecular weight molecules. Referring now to FIG. 2A in particular, it is well-known that a conventional homopolymer of polypropylene will break shortly after it has reached its elongation at peak tensile strength during testing (with increasing elongation). Thus the elongation at break is not much higher than the elongation at the peak tensile strength (commonly referred to as the peak elongation). This is reflected in the top two curves 20a, 20b of FIG. 2A which represent the stress/strain curve for a conventional polypropylene homopolymer at different crosshead speeds (the higher curve 20a being the testing at slower crosshead speeds (100 mm/min) and the lower curve 20b being the testing at faster crosshead speeds (500 mm/min). Thus, a web made of a conventional homopolymer of polypropylene typically breaks well before 400% elongation. Similarly, a web made of a conventional homopolymer of polypropylene typically either breaks or at least has a tensile strength which is less than 40% of the peak tensile strength at 250% elongation.

By way of contrast, as illustrated in the bottom two curves 20c, 20d of FIG. 2A, the webs formed of the novel homopolymer do not break even when the elongation is increased substantially above the elongation at peak tensile strength. Thus, a web made of the novel homopolymer typically exhibits in at least one direction at 400% elongation (and preferably at 450% elongation) a tensile strength which is still at least 10% of the peak tensile strength for that web, and at 250% elongation a substantial tensile strength which is still at least 40% (and preferably 50%) of the peak tensile strength for that web.

It is theorized that the ability of a web made of the novel homopolymer composition (in combination with the modified process parameters) to sustain without major fracture or failure an elongation greater than the break elongation of a web made of a conventional homopolymer results, at least in part, from the skewed molecular weight distribution of the novel homopolymer. As earlier noted, it is well recognized that the high molecular weight molecules of a homopolymer are a significant factor in contributing to the tensile strength of a web made therefrom. However, in a conventional homopolymer, the proportion of the high molecular weight molecules also contributes to a high level of crystallization within the homopolymer due to the resultant narrow molecular weight distribution. Thus, the conventional homopolymer tends to break shortly after application of the peak tensile stress, and the elongation at break tends to be only slightly higher than the elongation at peak tensile strength. It is theorized that the presence of a substantial number of low molecular weight molecules in the novel homopolymer (with its skewed molecular weight distribution) serves as a plasticizer for the high molecular weight molecules by decreasing the crystallinity of the homopolymer and increasing its amorphous behavior. Thus the peak tensile strength of a web made therefrom is lower, but the web retains its coherency (without effective rupture) well beyond the elongation at peak tensile strength and typically even at 400% or 450% elongation.

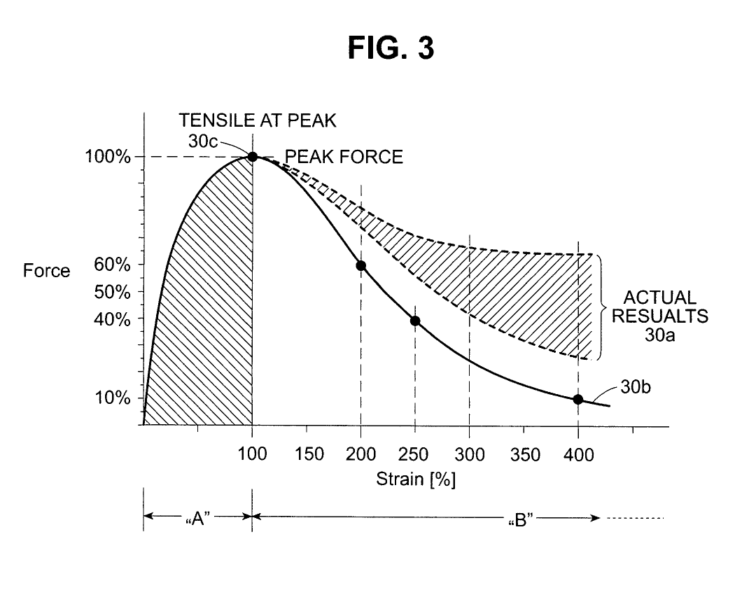

While the first two factors or characteristics discussed above represent static snapshots of the stress/strain curve at specific elongations, the third factor or characteristic is more of a motion picture of the history of the web and its performance under stress/strain conditions. Referring now to FIGS. 2B and 3 in particular, for the web of the present invention the area B under the stress/strain curve after the peak tensile strength (i.e., to the right thereof) is greater than the area A under the stress/strain curve before the peak tensile strength (i.e., to the left thereof). The total area under the stress/strain curve is representative of the viscoelastic deformation energy, which in turn is related to toughness. Thus, as illustrated in FIG. 2B, the areas A1, A2, A3 under the curves represent the viscoelastic deformation energy before the peak tensile strength is reached, while the areas B1, B2, B3 under the curves represents the viscoelastic deformation energy from the peak tensile strength to break or at least to 1% of the peak tensile strength, whichever occurs first. (The A1, A2, A3 and the associated B1, B2, B3 indicate measurements on the same web using different grip distance during testing, as explained hereinabove.) The limit of “1% of the peak tensile strength” is used simply because frequently a web formed of the novel homopolymer will continue to deform (stretch) without breaking during the normal test cycle. The “1% of peak tensile strength” simply provides an upper limit to the elongation process in such a case.

Thus, the ratio of the viscoelastic deformation energy after peak tensile B to the viscoelastic deformation energy before peak tensile A is typically greater than one according to the present invention, and preferably greater than two. The Instron Series IX Tensile Tester is capable of providing a measure of the viscoelastic deformation energy to peak tensile (or “work to maximum load”), depending upon the software setup and the calculation mode, as an energy to yield. The energy to yield for a homopolymer of polypropylene is a close approximation of the energy to peak tensile. As will be appreciated from inspection of curves 20a, 20b of FIG. 2A, the viscoelastic deformation energy after peak tensile is limited by the imminent break of the standard web. But, as will be apparent from an inspection of curves 20c, 20d of FIG. 2A and from FIG. 3, the novel web of the present invention continues to elongate well beyond the peak tensile so that additional viscoelastic deformation energy is required to create the further deformation. Either manually or through a software modification of the tensile tester, the viscoelastic deformation energy after the peak tensile may be calculated as the energy to break (or 1% of the peak tensile strength) minus the energy to peak tensile (which, as noted above, may be approximated by the energy to yield).

Referring now in particular to FIG. 3, therein illustrated is a modified stress/strain curve. The stress or force required to produce a given elongation is indicated not in the standard units of force (Newtons) but rather as a percentage of the peak tensile or peak force. Thus a stress of 100% of the peak tensile stress is required to produce the peak elongation (that is, the elongation at peak tensile). Further, a shaded area 30a to the right of the peak elongation represents a range of actual test results (indicated between broken lines). By way of contrast, the solid-line curve 30b to the right of the peak elongation 30c represents the curve mandated by the factors or characteristics (i), (ii) and (iii), as set forth hereinabove. It will be appreciated that this hypothetical solid-line curve shows tensile strengths less than the actual test results at the same elongations so that the actual test results easily meet the more stringent hypothetical requirements. Additionally, it will be noted that the ratio of the viscoelastic deformation energy after the peak tensile strength (denoted B) to the viscoelastic deformation energy before the peak tensile strength (denoted A) is greater than one for both the actual test results and the hypothetical curve.

Taylor, et al., U.S. Patent Publication No. 2002/0063364 A1, published May 30, 2002, discloses a system and process for producing multicomponent (e.g., bicomponent) spunbonded nonwoven fabrics. Components of the apparatus (including the quench chamber, and the filament-drawing and filament-depositing units) are described therein as available commercially from Reifenhauser GmbH & Company Machinenfabrik of Troisdorf, Germany under the commercial name of REICOFIL III. The publication is incorporated herein by reference, as is U.S. Pat. No. 5,814,349 which describes the system more fully. For the present invention wherein only a single novel homopolymer is used to form the product, the second inlet hopper and second extruder are unnecessary and the distributor plate of the spinnerette may be simplified for a monofilament operation.

It has been found that to form a web which is plastically deformable when subjected to high speed incremental deformation, the spunbond nonwoven web from the novel homopolymer should be formed according to the above-mentioned process using the following modified process parameters: quench air at 8-20° C. (preferably about 12-14° C.), a fiber speed of 500-2,500 meters/minute (preferably 1,000-2,000 meters/minute), and a bonding temperature of 75-150° C. (preferably 110-125° C.). The plastically deformable nature of the resultant web contributes to its structural extensibility in at least one direction (preferably the cross direction or CD of the web for a diaper).

The novel web of the present invention is advantageously fusion bonded by passing the same through a calender nip between a heated pattern roll and a heated smooth anvil roll. Preferably the patterned roll forms an asymmetric bonding pattern such as the asymmetric bonding pattern of discrete oval bonding points disclosed in Kauschke, et al. U.S. Pat. No. 6,537,644, U.S. Pat. No. 6,610,390 and U.S. Patent Application Publication No. 2002/0036062 A1, published Mar. 28, 2002, each of these documents being incorporated herein by reference. Such a pattern is identified by the mark PILLOW BOND of First Quality Nonwovens, Inc.

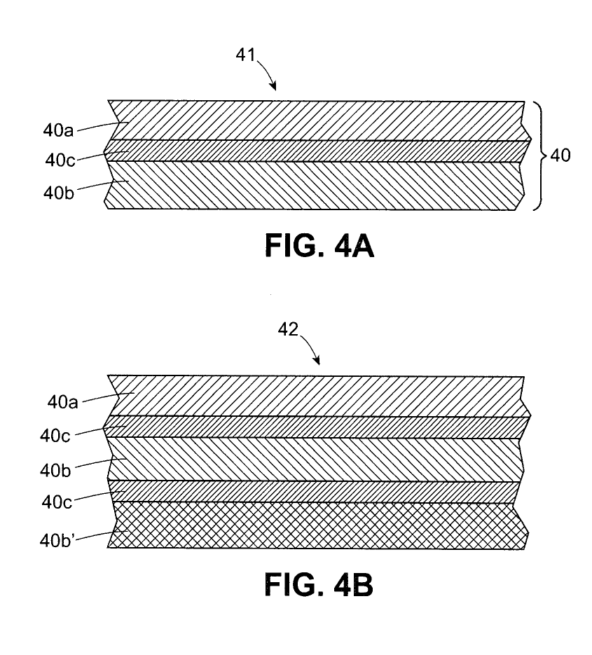

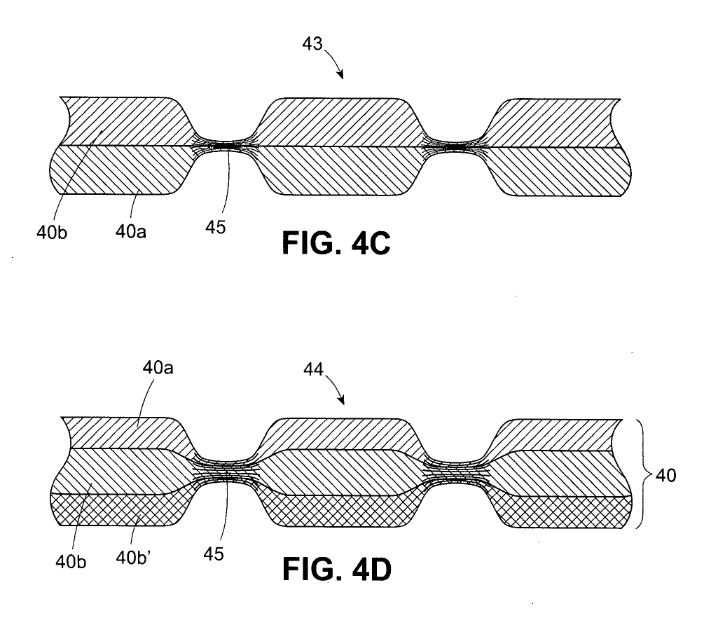

Referring now to FIGS. 4A through 4D in particular, the web of the present invention further finds utility in a multilayer laminate or composite, generally designated 40, comprising the novel web 40a and at least one other web 40b selected from the group consisting of non-wovens, woven textiles, films and combinations thereof. As will be appreciated by those familiar with the composite art, the at least one other web 40b may be elastic or non-elastic, breathable or non-breathable, etc. The at least one other web 40b is preferably a non-woven (and hence breathable) or a breathable film, on the one hand, or an elastic non-woven or an elastic film, on the other hand. A preferred one other web 40b is a film formed of a homopolymer of polyethylene. The composite 40 may include an adhesive 40c and additional webs 40b′.

More particularly, FIG. 4A shows an adhesively bonded 2-layer composite generally designated 41, and FIG. 4B shows an adhesively bonded 3-layer composite generally designated 42. FIG. 4C shows a non-adhesively bonded 2-layer composite generally designated 43, and FIG. 4D shows a non-adhesively bonded 3-layer composite generally designated 44. The non-adhesive bonding may be accomplished by thermal, ultrasonic, fusion or like techniques, thermal bonds 45 being shows in FIGS. 4C and 4D.

Where the other sheets or layers of the composite or laminate are elastic in nature, the ability of the novel web 40a to follow the stress/strain movements of the laminate, without complete failure, breakage or disintegration of the structure, renders the composite highly resistant to frequent hysteresis stress/strain deformation. Further, where the novel web 40a defines an outer surface of the composite, it affords a soft and textile-like surface to the composite.

Because the multilayer laminate or composite 40 may be selected so that the stretchability of the novel web 40a and at least one other web 40b are compatible, the possibility of accidental separation of the webs of the composite 40 may be minimized.

There are various types of bicomponent fibers, generally designated 50.

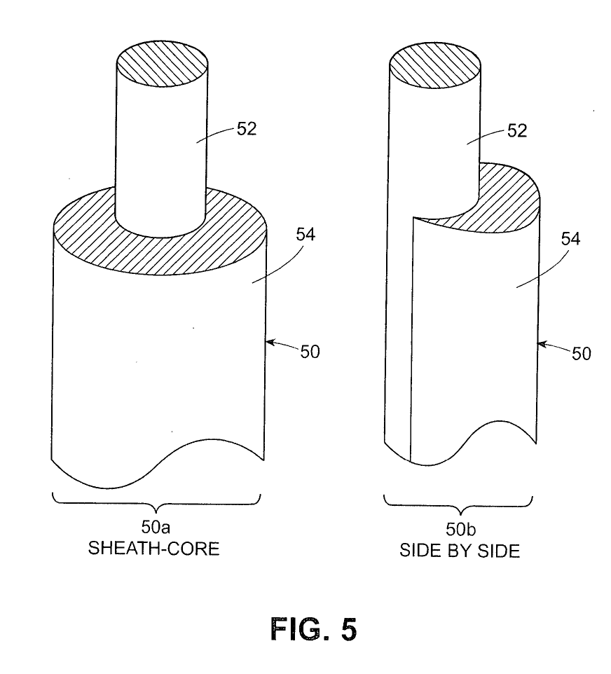

The well-known sheath/core bicomponent fibers 50 (illustrated at the left of FIG. 5) typically have a “matrix” polymer as the core to provide strength and a lower melting “binder polymer” as the sheath to facilitate thermo-bonding of the bicomponent fiber without damage to the matrix polymer. The thermo-bonding may be performed by a variety of techniques well-known in the art including fusion bonding (such as calendering), ultrasonic bonding, through-air bonding, and the like. Typically the matrix polymer or core is polypropylene, while the binder polymer or sheath is polyethylene in order to provide a softness and extensibility to the bicomponent fiber which cannot be achieved with polypropylene. Alternatively, the matrix polymer or core is polypropylene or polyethyleneterephthalate with a binder polymer or sheath of polyethylene in order to provide a soft outer surface and high drapability for the bicomponent fiber.

The well-known side-by-side bicomponent fibers 50b (illustrated at the right of FIG. 5) undergo a high degree of crimping, with resultant spiral formation, as a result of the different shrinkage of the two polymers under thermal changes. Such a “bimetal effect” provides a high bulk 3D structure nonwoven which is softer and has more bulk/caliper than a typical spunbond nonwoven. Typical carded webs used for hygienic articles contain about 10-50% by weight of such crimped bicomponent fibers to provide the desired softness and bulk caliper.

Typically both sheath/core bicomponent fibers and side-by-side bicomponent fibers utilize polymers where disengagement of the two component polymers at their mutual adhesion surface is minimal in order to preserve the mechanical fabric properties of the nonwoven.

The novel polypropylene homopolymer 52 may be used in a sheath/core bicomponent fiber as the core (typically with polyethylene 54 or a copolymer of polyethylene as the sheath) in order to lower the differential shrinkage behavior between the two component polymers and/or to improve the thermal bonding window so there is less likelihood of component separation during use of the bicomponent fiber. The novel polypropylene homopolymer 52 may also be used in a side-by-side bicomponent fiber (typically with either conventional polypropylene or polyethylene 54 or a copolymer of polyethylene) to provide improved bonding strength with the softening/melting bonding polymer 54 or simply to provide a bimetal effect.

Where the components of the bicomponent fiber 50 are the novel homopolymer of polypropylene and a homopolymer of polyethylene, the components are substantially similar in shrinkage characteristics as a function of temperature, plastic deformation characteristics and the capacity to bond with other polymeric materials. Thus there is less likelihood of the components separating during use. While the cost of such a bicomponent fiber exceeds that of a monocomponent fiber, as previously described, the bicomponent fibers of the present invention are highly desirable since the common characteristics of the novel homopolymer and polyethylene components render a web made from the bicomponent fibers especially well suited for a number of applications wherein a conventional bicomponent fiber would not be suitable (due to the likelihood of separation of the components from one another thereof when plastically deformed).

A third type of bicomponent fibers is “splittable fibers.” Such splittable fibers are typically formed of at least two or more component polymers in a “pie” cross section (with 4, 6, 8 or 16 pie-cuts with differing adjacent component polymers), or any other cross-section arrangement wherein the at least two components polymers are designed to split apart to form very fine fibers (according to their size) during or after mechanical, chemical or thermal secondary treatment. Here it is essential to use component polymers with a minimal tendency to adhere together. Hydraulic secondary treatment is frequently used to simultaneously split and entangle the split fibers. The novel polypropylene homopolymer composition further finds utility in such splittable fibers (typically made with conventional polypropylene or with polyethylene or a copolymer of polyethylene, as another component polymer). The polymers of the splittable bicomponent fiber are preferably substantially non-adherent to one another to facilitate intentional splitting thereof during secondary treatment.

A web according to the present invention finds extreme utility in forming either a hydroentangled or hydroengorged single layer non-woven or a hydroentangled or hydroengorged multilayer laminate or composite. The term “hydroengorged” is described more fully in U.S. patent application Ser. No. 10/938,079, filed Sep. 10, 2004 which is hereby incorporated by reference.

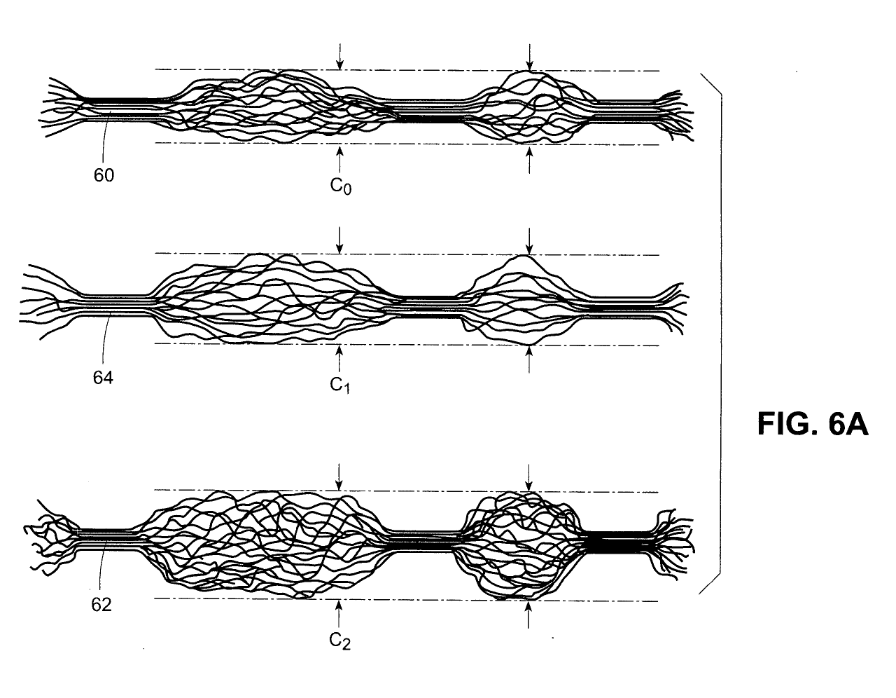

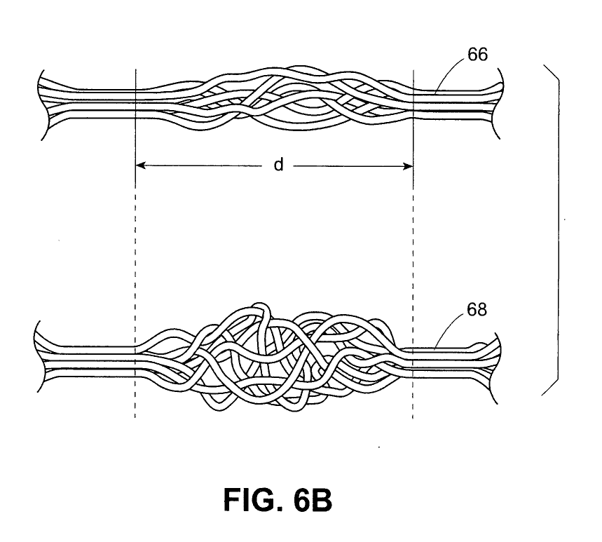

Referring now to FIG. 6A in particular, therein illustrated at the top thereof is the caliper or thickness of a single layer spunbond web according to the present invention prior to hydroentanglement or hydroengorgement 60 and at the bottom thereof the same web after hydroentanglement or hydroengorgement 62. Not only is the caliper C₂ of the web after hydroentanglement or hydroengorgement 62 substantially greater than the caliper C₀ of the web prior to hydroentanglement or hydroengorgement 60, but the degree of entanglement is much greater. For comparative purposes, FIG. 6A illustrates in the center a comparable hydroentangled conventional web 64 having a caliper C, intermediate the calipers C₀ and C₂ of the webs 60, 62 according to the present invention, and a lesser degree of entanglement than the web according to the present invention after hydroentanglement 62. It is theorized that the ability of the length of the continuous fibers between bond points (i.e., the free fiber lengths) to undergo plastic deformation sufficiently to enable various portions of the fiber between bond points to more or less independently hydroentangle or hydroengorge with other fibers minimizes the undesirable disentanglement phenomenon. Accordingly, the web of the present invention is especially useful where high loft (i.e., caliper or thickness) and/or a high level of hydroentanglement or hydroengorgement is desired in the web.

Referring now to FIG. 6B in particular, therein illustrated is a portion 66 of a spunbond web according to the present invention prior to hydroentanglement or hydroengorgement 66 at the top and a portion 68 after hydroentanglement or hydroengorgement at the bottom. It will be appreciated that, while the free fiber length d (i.e., the distance between bond points) is not changed by the hydroentanglement, the fibers themselves become elongated and extended after the hydroentanglement treatment due to the mechanical stretching of fibers and the high degree of fiber entanglement. More particularly, it will be appreciated that the hydroentanglement treatment produces fibers of greater length and a higher degree of entanglement than would occur if a conventional spunbond web were comparably treated.

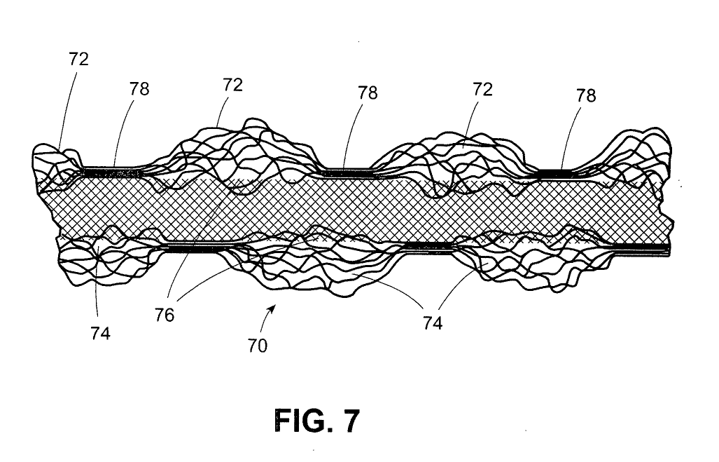

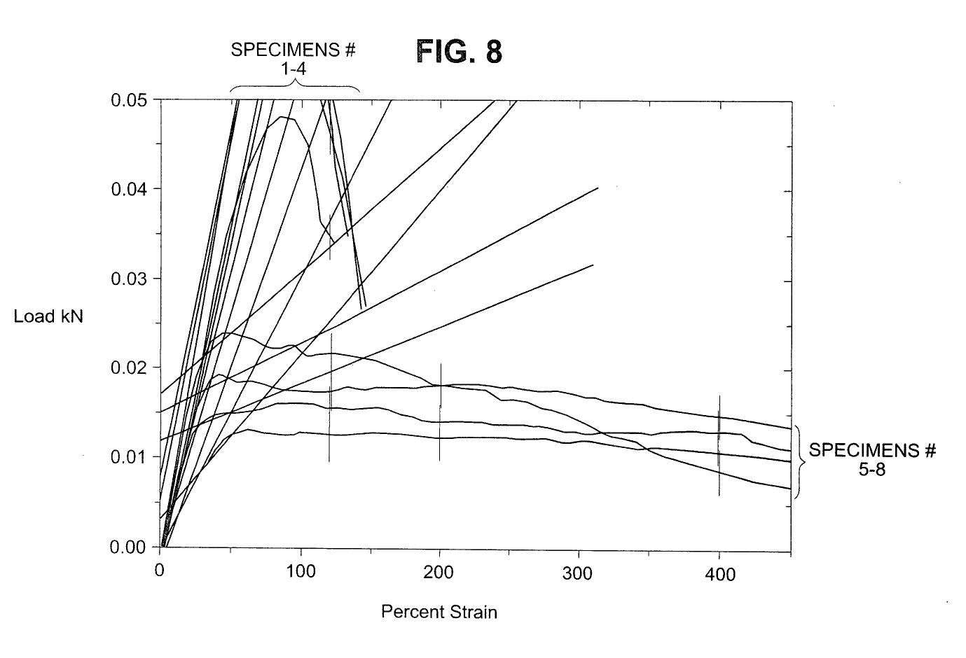

Referring now to FIG. 7, therein illustrated is a hydroentangled or hydroengorged laminate or composite, generally designated 70, wherein the two outer layers 72, 74 are spunbond webs according to the present invention and the middle layer 76 is formed of wood pulp fibers, cellulosic fibers, viscose fibers or combinations thereof. The three layers are placed in appropriate juxtaposition 72, 76, 74 and then subjected to conventional hydroentanglement. As illustrated, the pulp fibers 76 penetrate into the adjacent inner surfaces of the spunbond layers 72, 74 at various areas 76 intermediate bond points 78 to form a particularly strong laminate.

The novel web of the present invention is also especially useful for forming an apertured web suitable for use, for example, as an apertured topsheet. The novel web is additionally calendered to create frangible secondary bonds therein and then the additionally calendered web is plastically deformed by high speed incremental deformation to create apertures therein. The secondary bonding and aperturing process, as applied to a conventional web, is disclosed in Benson, et al. U.S. Pat. No. 5,628,097, Flohr, et al. U.S. Pat. No. 6,551,436, and Gillespie, et al. U.S. Pat. No. 6,632,504, each of these being incorporated herein by reference. The novel web uses the polypropylene homopolymer to achieve superior results (e.g., softness, hand strength, and abrasion resistance) relative to pure polyethylene and avoids the higher expense of bicomponent fibers, copolymer fibers, or pure polyethylene fibers.

Alternatively, the novel web of the present invention is also especially useful for forming an apertured nonwoven web. Thus, the novel web has apertures created therein by sucking hot air through a screen supporting the nonwoven web or by hot needling the nonwoven web—e.g., by hot air or hot needles.

The novel web of the present invention, by itself or as part of a laminate or composite, finds utility in a wide variety of applications including absorbent articles (e.g., diapers, catamenial pads, wipes, etc.), medical garments (e.g., surgical gowns, etc.), industrial protective garments (e.g., clean room clothing, etc.), home furnishings (e.g., furniture and bedding, etc.), filtration apparatus, and the like.

### EXAMPLES

### Example I

A novel homopolymer of propylene was obtained from ExxonMobil Chemical Company under the designation PP 3164 E-1. The composition had a melt flow rate (MFR) of 23-25 grams/10 minutes (ASTM D-1238, Condition L, 230° C./2.16 kg) and a polydispersity (Mw/Mn) of about 3. Continuous fibers were formed from the homopolymer and spunbond to form a spunbond non-woven web having a weight of 35 grams/square meter (gsm) according to the process described in Taylor, et al. U.S. Patent Application Publication No. 2002/0063364 A1, published May 30, 2002, and Bugada, et al. U.S. Pat. No. 6,569,945, both hereby incorporated by reference. The apparatus illustrated in Taylor was modified to use only a single hopper and a single extruder, with the spinning or production plates also being appropriately modified to produce a monocomponent spunbond rather than a multicomponent spunbond.

The main spinning process conditions were set at a quench air temperature of 14° C., an average fiber velocity of 1,900 meters per minute (m/min), and a bonding temperature in the calender nip of 120° C. More particularly, the non-woven web was fusion bonded by passing the same through a calender nip between a heated patterned roll and a heated smooth anvil roll. The patterned roll formed an asymmetric bonding pattern of discrete oval bonding points as disclosed hereinabove and characterized by the mark PILLOW BOND of First Quality Nonwovens, Inc.

The resultant webs had a state-of-the-art level of uniformity and a related low weight variation.

The physical properties and characteristics of the resultant webs were evaluated using conventional test methods, as described in ASTM 5035-95 and EDANA 20.2-89, but with the setup conditions modified to highlight the objects and results of the present invention. Thus, the tests were run with various crosshead speeds of 100, 300, 450 and 500 millimeters per minute and various grip distances of 0.5, 2 and 4 inches, with the results set forth in Table I. Each datum shown on the Table is an average of data taken from at least 30 specimens. A dash (-) in the Table indicates that the datum could not be obtained due to sample breakage.

Also shown in Table I for comparative purposes is a control web of continuous spunbond fibers formed from a conventional homopolymer of polypropylene available either from ExxonMobil Chemical Company under the commercial designation PP 3155 or from Basell USA, Inc., under the commercial designation PXPH 835, both resins having a melt flow rate of 36. The conventional polypropylene homopolymer was processed under conventional processing conditions with a quench air temperature of 20° C., a fiber velocity of 2,500 meters per minute, and a bonding temperature in the calender nip of 158° C.

The data of Table I evidences the plastic deformation of the non-woven web according to the present invention, especially when the web was subjected to higher crosshead speeds and shorter grip distances (simulating incremental high speed deformation processes and excluding progressively the influence of the web formation), and the ratio between the energy used for the plastic (viscoelastic) deformation of the web to reach the tensile peak and the additional plastic deformation energy required to cause the web to break.

### Example II

The procedure of Example I was repeated except that all tests were performed at a crosshead speed of 500 mm/minute and a grip distance of 0.5″.

The evaluation results are recorded in Table II. FIG. 8 illustrates the stress/strain graphs of typical specimens, with specimens #1 through 4 being the conventional homopolymer of polypropylene and specimens #5 through 8 being the novel homopolymer of polypropylene according to the present invention.

While the physical properties and characteristics of the typical specimens evaluated in Example II are not in 100% agreement with the evaluation results of Table I (for evaluations at the same crosshead speed and grip distance), the evaluation results of Tables I and II are within a reasonably anticipatable range taking into consideration the non-uniformity of the fabric which can lead to different evaluation results even for different samples of the same fabric roll.

### Example III

The procedure of Example II was repeated, this time with all webs (both novel and conventional) having a weight of 15 gsm rather than 35 gsm.

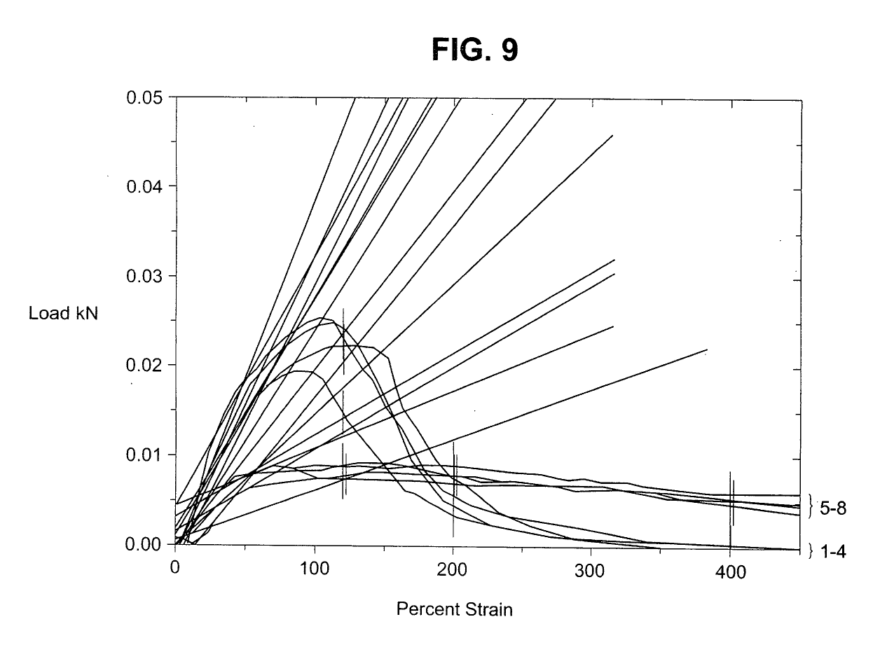

The physical properties and characteristics are recorded in Table III. FIG. 9 illustrates the stress/strain graph of typical specimens, with specimens #1-4 being the conventional homopolymer of polypropylene and specimens #5-8 being the novel homopolymer of polypropylene according to the present invention. It will be appreciated that the graph correctly indicates that the conventional specimens #5-8 of the heavy 35 gsm material of Examples I and II broke at the higher elongations; but, due to limitations of the graphing equipment used, the graph incorrectly indicates that the conventional specimens of the lighter weight 15 gsm material did not show breakage, even at the higher elongations, although in fact there was effective rupture of such specimens.

### Example IV

In order to illustrate the efficacy of the present invention in connection with a different novel homopolymer of polypropylene in combination with the modified process parameters according to the present invention, the procedure of Example II was repeated with a novel homopolymer of polypropylene obtained from ExxonMobil Chemical Company under the designation 3104E-1 having a melt flow rate of 18. Two webs were made at weights of 18 and 40 gsm. The web temperature in the calender nip was 125° C. (instead of 120° C.). The physical properties and characteristics are reported in Table IV. There were no control webs.

To summarize, the present invention provides a nonwoven web formed of substantially continuous spunmelt fibers comprising a novel homopolymer of polypropylene, the web being plastically deformable when subjected to high speed incremental deformation to contribute to the structural extensibility thereof in at least one direction. The continuous fibers of such a web may be hydroentangled or hydroengorged either with themselves or other fibers. A hydroentangled or hydroengorged laminate may comprise, for example, two outer spundbond layers according to the present invention and an intermediate layer therebetween formed of wood pulp, cellulosic fibers, viscose fibers or combination thereof. A composite or laminate may be formed of such a web and a nonwoven or film, the nonwoven or film preferably being elastic and/or breathable. A bicomponent fiber may comprise in combination a component of the novel homopolymer of polypropylene and a component of polyethylene, both components being substantially similar in shrinkage characteristics as a function of temperature, in plastic deformation characteristics, and in the capacity to bond with other polymeric materials. Finally, the present invention provides a method for making such a monocomponent fiber of polypropylene from the novel homopolymer, such a bicomponent fiber, and such a web, composite or laminate.

Now that the preferred embodiments of the present invention have been shown and described in detail, various modifications and improvement thereon will become readily apparent to those skilled in the art. Accordingly, the spirit and scope of the present invention is to be construed broadly and limited only by the appended claims, and not by the foregoing specification.

TABLE I

| | | | | | | | | | | | | | Control |
|---|---|---|---|---|---|---|---|---|---|---|---|---|---|
| Grip Distance [inch] | 0.5 | 0.5 | 0.5 | 0.5 | 2 | 2 | 2 | 2 | 4 | 4 | 4 | 4 | 0.5 |
| Crosshead Speed | 100 | 300 | 450 | 500 | 100 | 300 | 450 | 500 | 100 | 300 | 450 | 500 | 500 |
| (mm/mn) | | | | | | | | | | | | | |
| Tensile at peak (N) | 20.5 | 17.5 | 15.5 | 12.5 | 16.1 | 14.0 | 13.7 | 12.3 | 15.7 | 16.1 | 14.2 | 11.2 | 59.2 |
| Elongation at peak | 62.6 | 60.2 | 53.8 | 50.4 | 36.7 | 24.6 | 29.2 | 23.9 | 37.0 | 29.4 | 41.3 | 28.9 | 95 |
| tensile [%] | | | | | | | | | | | | | |
| Tensile at 120% E [N] | 17.7 | 16.1 | 14.5 | 11.6 | 10.7 | 7.9 | 8.6 | 6.9 | 4.2 | 3.9 | 5.2 | 4.8 | 42 |
| Tensile at 200% E [N] | 13.3 | 14.9 | 15.1 | 11.7 | 4.9 | 4.7 | 3.8 | 3.6 | 0.9 | 0.8 | 1.5 | 1.2 | — |
| Tensile at 400% E [N] | 10.5 | 10.6 | 13.2 | 10.7 | 0.7 | 1.2 | 0.9 | 0.9 | — | — | 0.2 | 0.2 | — |
| Tensile at 450% E [N] | 9.6 | 9.7 | 12.5 | 9.8 | 0.4 | 0.3 | 0.2 | 0.2 | — | — | 0.1 | 0.1 | — |
| Energy to peak tensile | 0.089 | 0.078 | 0.062 | 0.034 | 0.208 | 0.104 | 0.150 | 0.095 | 0.424 | 0.349 | 0.356 | 0.209 | 0.435 |
| [J] (A) | | | | | | | | | | | | | |
| Energy to break [J] (B) | 0.667 | 0.669 | 0.959 | 0.934 | 0.786 | 0.759 | 0.704 | 0.642 | 0.683 | 0.789 | 1.007 | 0.810 | 0.203 |
| B/A ratio | 7.49 | 8.58 | 15.47 | 27.47 | 3.78 | 7.3 | 4.7 | 6.76 | 1.61 | 2.26 | 2.86 | 3.88 | 0.49 |

TABLE II

| | Control | Invention |
|---|---|---|
| Crosshead Speed (mm/mn) | 500 | 500 |
| Grip Distance [inch] | 0.5 | 0.5 |
| Tensile at peak (N) | 59.2 | 15.2 |
| Elongation at peak tensile [%] | 95 | 60.5 |
| Tensile at 120% E [N] | 42 | 15.9 |
| Tensile at 200% E [N] | — | 14.8 |
| Tensile at 400% E [N] | — | 11.8 |
| Tensile at 450% E [N] | — | 9.2 |
| Energy to peak tensile [J] | 0.435 | 0.093 |
| Energy to break [J] | 0.203 | 0.928 |
| B/A ratio | 0.49 | 9.98 |

TABLE III

| | Control | Invention |
|---|---|---|
| Grip Distance [inch] | 0.5 | 0.5 |
| Crosshead Speed (mm/mn) | 500 | 500 |
| Tensile at peak (N) | 24.7 | 8.95 |
| Elongation at peak tensile [%] | 110.4 | 155.4 |
| Tensile at 120% E [N] | 22.42 | 8.08 |
| Tensile at 200% E [N] | 4.82 | 7.76 |
| Tensile at 400% E [N] | 0.35 | 5.24 |
| Tensile at 450% E [N] | 0.12 | 4.58 |
| Energy to peak tensile [J] (A) | 0.211 | 0.110 |
| Energy to break [J] (B) | 0.332 | 0.345 |
| B/A ratio | 0.94 | 3.9 |

TABLE IV

Weight (gsm)

| | 40 | 18 |
|---|---|---|
| Grip Distance [inch] | 0.5 | 0.5 |
| Crosshead Speed (mm/mn) | 500 | 500 |
| Tensile at peak (N) | 31.92 | 12.85 |
| Elongation at peak tensile [%] | 175.16 | 201.2 |
| Tensile at 120% E [N] | 30.93 | 10.4 |
| Tensile at 200% E [N] | 29.32 | 10.1 |
| Tensile at 400% E [N] | 18.56 | 8.14 |
| Tensile at 450% E [N] | 15.2 | 6.82 |
| Energy to peak tensile [J] (A) | 0.465 | 0.204 |
| Energy to break [J] (B) | 0.755 | 0.273 |
| B/A ratio | 1.62 | 1.34 |

1. A nonwoven web formed of substantially continuous spunmelt fibers comprising a homopolymer of polypropylene;
said web, when subjected to high speed incremental deformation, being plastically deformed and, in at least one direction, being characterized by at least one of:
(i) a tensile strength at 400% elongation which is at least 10% of the peak tensile strength,
(ii) a tensile strength at 250% elongation which is at least 40% of the peak tensile strength, and
(iii) a ratio of the viscoelastic deformation energy after the peak tensile strength to the viscoelastic deformation energy before the peak tensile strength which is greater than one.

2. The web of claim 1 wherein said homopolymer is a physical blend of at least two homopolymers of polypropylene, at least one of said at least two homopolymers having a polydispersity of less than 3.3, and said at least two homopolymers having a substantially different weight average molecular weight, and after blending said at least two homopolymers in combination having a skewed molecular weight distribution and a polydispersity of less than 3.5.

3. The web of claim 2 wherein said skewed molecular weight distribution is characterized:
(i) below the peak weight average molecular weight, by a gradual slope and a long tail towards the low molecular weights, and
(ii) above the peak weight average molecular weight, by a steep slope and a short tail towards the high molecular weights.

4. The web of claim 1 wherein said homopolymer is a reaction product having a polydispersity of less than 3.5 and a skewed molecular weight distribution.

5. The web of claim 4 wherein said skewed molecular weight distribution is characterized:
(i) below the peak weight average molecular weight, by a gradual slope and a long tail towards the low molecular weights, and
(ii) above the peak weight average molecular weight, by a steep slope and a short tail towards the high molecular weights.

6. The web of claim 1 wherein the high speed incremental deformation is at least 400 mm/minute applied to an original undeformed dimension not greater than 0.5 inch.

7. The web of claim 1 wherein the high speed incremental deformation occurs at a web temperature of 50-80° C.

8. The web of claim 1 wherein the high speed incremental deformation occurs at an ambient web temperature.

9. The web of claim 1 wherein said continuous fibers are spunbond and have a diameter of 10-50 microns.

10. The web of claim 1 wherein said continuous fibers are meltblown and have a diameter of 0.5-10 microns.

11. The web of claim 1 which is characterized by at least two of characteristics (i), (ii), and (iii).

12. The web of claim 1 which is characterized by each of characteristics (i), (ii), and (iii).

13. The web of claim 1 wherein said continuous fibers of said web are hydroentangled or hydroengorged.

14. The web of claim 1 wherein said continuous fibers of said web are asymmetrically bonded.

15. The web of claim 1 wherein said ratio is at least two.

16. The web of claim 1 wherein said tensile strength at 450% elongation is at least 10% of said peak tensile strength.

17. The web of claim 1 wherein said tensile strength at 250% elongation is at least 50% of said peak tensile strength.

18. A nonwoven web formed of substantially continuous spunmelt fibers comprising a homopolymer of polypropylene, said homopolymer being one of
(i) a physical blend of at least two homopolymers of polypropylene, at least one of said at least two homopolymers having a polydispersity of less than 3.3, said at least two homopolymers having a substantially different weight average molecular weight, and after blending said at least two homopolymers in combination having a skewed molecular weight distribution and a polydispersity of less than 3.5; and
(ii) a reaction product having a polydispersity of less than 3.5 and a skewed molecular weight distribution;
said web, when subjected to high speed incremental deformation, is plastically deformed and has a structural extensibility in at least one direction.

19. The web of claim 18 wherein said skewed molecular weight distribution is characterized:
(i) below the peak weight average molecular weight, by a gradual slope and a long tail towards the low molecular weights, and
(ii) above the peak weight average molecular weight, by a steep slope and a short tail towards the high molecular weights.

20. The web of claim 18 wherein the high speed incremental deformation is at least 400 mm/minute applied to an original undeformed dimension not greater than 0.5 inch.

21. The web of claim 18 wherein the high speed incremental deformation occurs at a web temperature of 50-80° C.

22. The web of claim 18 wherein the high speed incremental deformation occurs at an ambient web temperature.

23. The web of claim 18 wherein said continuous fibers are spunbond and have a diameter of 10-50 microns.

24. The web of claim 18 wherein said continuous fibers are meltblown and have a diameter of 0.5-10 microns.

25. The web of claim 18 wherein said continuous fibers of said web are hydroentangled or hydroengorged.

26. The web of claim 18 wherein said continuous fibers of said web are asymmetrically bonded.

27. The web of claim 18 wherein said homopolymer is said physical blend.

28. The web of claim 18 wherein said homopolymer is said reaction product.

29. The web of claim 18 wherein said structural extensibility in at least one direction is characterized by at least one of:
(i) a tensile strength at 400% elongation which is at least 10% of the peak tensile strength,
(ii) a tensile strength at 250% elongation which is at least 40% of the peak tensile strength, and
(iii) a ratio of the viscoelastic deformation energy after the peak tensile strength to the viscoelastic deformation energy before the peak tensile strength which is greater than one.

30. The web of claim 29 which is characterized by at least two of characteristics (i), (ii), and (iii).

31. The web of claim 29 which is characterized by each of characteristics (i), (ii), and (iii).

32. The web of claim 29 wherein said ratio is at least two.

33. The web of claim 29 wherein said tensile strength of 450% elongation is at least 10% of said peak tensile strength.

34. The web of claim 29 wherein said tensile strength at 250% elongation is at least 50% of said peak tensile strength.

35. The web of claim 18 wherein said continuous fibers of said web are asymmetrically bonded.

36. A method of making a nonwoven web formed of substantially continuous spunmelt fibers, comprising the step of:
forming a spunbond nonwoven web comprising essentially of fibers of a homopolymer of polypropylene using:
(i) quench air at 8-20° C.,
(ii) a fiber speed of 500-2,500 meters/minute, and
(iii) a bonding temperature of 75-150° C.;
thereby to form a web which, when subjected to high speed incremental deformation, is plastically deformed and, in at least one direction, is characterized by at least one of:
(i) a tensile strength at 400% elongation which is at least 10% of the peak tensile strength,
(ii) a tensile strength at 250% elongation which is at least 40% of the peak tensile strength, and
(iii) a ratio of the viscoelastic deformation energy after the peak tensile strength to the viscoelastic deformation energy before the peak tensile strength which is greater than one.

37. The method of claim 36 wherein
(i) the quench air is about 12-14° C.,
(ii) the fiber speed is about 1,000-2,000 meters/minute, and
(iii) the bonding temperature is about 110-125° C.

38. The method of claim 36 wherein the homopolymer is a physical blend of at least two homopolymers of polypropylene, at least one of the at least two homopolymers having a polydispersity of less than 3.3, and the at least two homopolymers having a substantially different weight average molecular weight, and after blending the at least two homopolymers in combination having a skewed molecular weight distribution and a polydispersity of less than 3.5.

39. The method of claim 38 wherein the skewed molecular weight distribution is characterized:
(i) below the peak weight average molecular weight, by a gradual slope and a long tail towards the low molecular weights, and
(ii) above the peak weight average molecular weight, by a steep slope and a short tail towards the high molecular weights.

40. The method of claim 36 wherein the homopolymer is a reaction product having a polydispersity of less than 3.5 and a skewed molecular weight distribution.

41. The method of claim 40 wherein the skewed molecular weight distribution is characterized:
(i) below the peak weight average molecular weight, by a gradual slope and a long tail towards the low molecular weights, and
(ii) above the peak weight average molecular weight, by a steep slope and a short tail towards the high molecular weights.

42. The method of claim 36 wherein the high speed incremental deformation is at least 400 mm/minute applied to an original undeformed dimension not greater than 0.5 inch.

43. The method of claim 36 wherein the high speed incremental deformation occurs at a web temperature of 50-80° C.

44. The method of claim 36 wherein the high speed incremental deformation occurs at ambient web temperature.

45. The method of claim 36 wherein the homopolymer exhibits a low elastic resistance during high speed incremental stretching.

46. The method of claim 36 wherein the fibers of the web have a diameter of 10-50 microns.

47. The method of claim 36 wherein the web is formed with an asymmetric bonding pattern.

48. The method of claim 47 wherein the asymmetric bond pattern is a PILLOW BOND pattern.

49. The method of claim 36 wherein the web is characterized by at least two of (i), (ii), and (iii).

50. The method of claim 36 wherein the web is characterized by each of (i), (ii), and (iii).

51. The method of claim 36 wherein the ratio is at least two.

52. The method of claim 36 wherein the tensile strength of 450% elongation is at least 10% of the peak tensile strength.

53. The method of claim 36 wherein said tensile strength at 250% elongation is at least 50% of the peak tensile strength.

54. A bicomponent fiber comprising:
(i) a component of polyethylene or polypropylene polymer, and
(ii) a component of polypropylene homopolymer, said polypropylene homopolymer being one of:
(a) a physical blend of at least two homopolymers of polypropylene, at least one of said at least two homopolymers having a polydispersity of less than 3.3, and said at least two homopolymers having a substantially different weight average molecular weight, and after blending said at least two homopolymers in combination having a skewed molecular weight distribution and a polydispersity of less than 3.5, and
(b) a reaction product having a polydispersity of less than 3.5 and a skewed molecular weight distribution.

55. The bicomponent fiber of claim 54 wherein said components are in a sheath/core configuration and are substantially similar in shrinkage characteristics as a function of temperature, in plastic deformation characteristics, and in the capacity to bond with other polymeric materials.

56. The bicomponent fiber of claim 54 wherein said components are in a side-by-side configuration, and are substantially dissimilar in shrinkage characteristics as a function of temperature.

57. The bicomponent fiber of claim 54 wherein said components are in a pie configuration and are substantially non-adherent to one another.

58. A multilayer laminate or composite comprising:
(i) the web of claim 1; and
(ii) at least one other web selected from the group consisting of nonwovens, woven textiles, films and combinations thereof.

59. The composite of claim 58 wherein said at least one other web is a nonwoven.

60. The composite of claim 58 wherein said at least one other web is a woven textile.

61. The composite of claim 58 wherein said at least one other web is one of a nonwoven and a breathable film.

62. The composite of claim 61 wherein said at least one other web is a nonwoven.

63. The composite of claim 61 wherein said at least one other web is a breathable film.

64. The composite of claim 58 wherein said at least one other web is one of an elastic nonwoven and an elastic film.

65. The composite of claim 64 wherein said at least one other web is an elastic nonwoven.

66. The composite of claim 64 wherein said at least one other web is an elastic film.

67. The composite of claim 58 wherein said at least one other web is a film of polyethylene homopolymer.

68. A hydroentangled or hydroengorged spunbond web made of the web of claim 1.

69. A hydroentangled or hydroengorged laminate comprising:
(i) two outer spunbond layers made of the web of claim 1, and
(ii) an intermediate layer therebetween formed at least of wood pulp, cellulosic fibers, viscose fibers or combinations thereof.

70. A method of forming an apertured web suitable for use as an apertured topsheet, comprising the steps of:
(i) providing the web of claim 1;
(ii) calendering the web to create frangible secondary bonds therein; and
(iii) plastically deforming the calendered web by high speed incremental deformation to create apertures therein.

71. A method of forming an apertured nonwoven web, comprising the steps of:
(i) providing the nonwoven web of claim 1; and
(ii) creating apertures in the nonwoven web by sucking hot air through a screen supporting the nonwoven web or by hot needling the nonwoven web.

72. A nonwoven web formed of substantially continuous spunmelt fibers comprising a homopolymer of polypropylene;
said web, when subjected to high speed incremental deformation, being plastically deformed and having a structural extensibility, in at least one direction, characterized by at least one of:
(i) a tensile strength at 400% elongation which is at least 10% of the peak tensile strength,
(ii) a tensile strength at 250% elongation which is at least 40% of the peak tensile strength, and
(iii) a ratio of the viscoelastic deformation energy after the peak tensile strength to the viscoelastic deformation energy before the peak tensile strength which is greater than one.
